(19) United States
(12) Patent Application Publication
(10) Pub. No.: US 2016/0201833 A1
(43) Pub. Date: Jul. 14, 2016

(54) FLEXIBLE COUPLING WITH SOLID LINER FLOW CONTROL

(71) Applicant: American BOA, Inc., Cumming, GA (US)

(72) Inventors: Eric Barbely, Atlanta, GA (US); Srinivas Gade, Cumming, GA (US)

(21) Appl. No.: 14/990,391

(22) Filed: Jan. 7, 2016

Related U.S. Application Data
(60) Provisional application No. 62/101,425, filed on Jan. 9, 2015.

(51) Int. Cl. F16L 27/11

(52) U.S. Cl. CPC F16L 27/11

(57) ABSTRACT

A flexible coupling used in coupling conduits for hot exhaust gas comprises a flexible bellow, a gas flow controlling element at a coupling entry end, and a discharge end. Gas flow within the coupling is concentrated and directed toward a coupling discharge end, away from the bellows. Any bellows flexible liner is eliminated. Gas flow in the coupling between the flow controlling element and the discharge end of the coupling is at least partially unconfined. Heat transfer to the bellows from the gas flow is diminished as compared to any other level of heat transfer if the hot gas flow engaged the bellows directly without the gas flow control provided herein.

### PRIORITY CLAIM

Applicant claims benefit of the filing date of Jan. 9, 2015 which is the filing date of U.S. Provisional Patent Application Ser. No. 62/101,425 which application is incorporated herein in its entirety as if fully set forth herein.

### FIELD OF THE INVENTION

This invention relates to flexible couplings used in exhaust gas flow system and particularly flexible couplings for coupling together conduits in hot exhaust gas system

### BACKGROUND OF THE INVENTION

Typical flexible couplings in exhaust gas systems include a flexible bellows of adjacent convolutions, a liner of spiral wound or interlock configurations, or dual, serially oriented liners, and an outer sleeve or braid of mesh material about the convolutions.

In such prior couplings, the liner(s) serves to reduce heat conduction from the hot gas flow to the bellows and sleeve. While advantageous, such liners have certain inherent problems. For example, such liners can touch the internal portions of the bellows, causing wear, heat conduction and noise. Since such liners are typically connected at each end of the bellows, they impart a degree of stiffness or rigidity to the coupling. This leads to varied stiffness and frictional concerns over time. The spiral or interlock liner elements, typically loosely interlocked but loosely provide flexibility, but also grate and wear on one another.

Applicant notes disclosures of U.S. Pat. No. 5,782,506; 7,581,563; and German disclosure DE 10 2012 219 458; each of which are herewith incorporated herein by reference for background as if fully set forth herein. While these illustrate other structural configurations of couplers, they present certain inherent disadvantages such as those noted above.

Accordingly it is one objective of the invention to provide an improved coupling having improved hot gas flow parameters.

A further objective of the invention has been to provide a flexible coupling without a spiral wound, interlock or dual liner but with improved gas flow characteristics reducing heat-conduction to the bellows, improving flexibility and reducing wear or components over time.

A further objective of the invention has been to provide an improved flexible coupling of reduced differential thermal responsiveness.

### SUMMARY OF THE INVENTION

A preferred embodiment of the invention includes a flexible coupling having a bellows of continuous multiple convolutions from end to end with a gas flow directing element or liner in a gas entry end of the bellows for reducing and directing hot gas flow to an exit end of the bellows. The flow directing and controlling element extends into the bellows is shorter than the length of the bellows so that a substantial portion of the gas flow path in the coupling is unconfined by such element or any other liner. For example, the gas flow directing element or liner is shorter than 50 percent of the length of the coupling, preferably shorter than 30 percent of the length of the coupling.

### BRIEF DESCRIPTION OF THE DRAWINGS

These and other objectives and advantages will become readily apparent from the following detailed description and from the drawings in which:

FIG. 1 is an elevational view in cross-section of a coupling according to the invention;

FIG. 2 is a cross-sectional enlarged view showing more detail within the encircled area A2 of FIG. 1;

FIG. 3 is an end view of one flow control element of the invention as in FIG. 1;

FIG. 4 is a cross-sectional view taken along lines 4-4 of FIG. 3;

FIG. 5A is an isometric view of a tapered flow control element as in FIGS. 1-4;

FIG. 5B is an isometric view of a tapered/straight flow control element;

FIG. 5C is an isometric view of a tapered flow control element, with a tapered tail end and;

FIG. 5D is an isometric view of a straight flow control element with a tapered upstream end, straight section and tapered end.

### DETAILED DESCRIPTION OF THE INVENTION

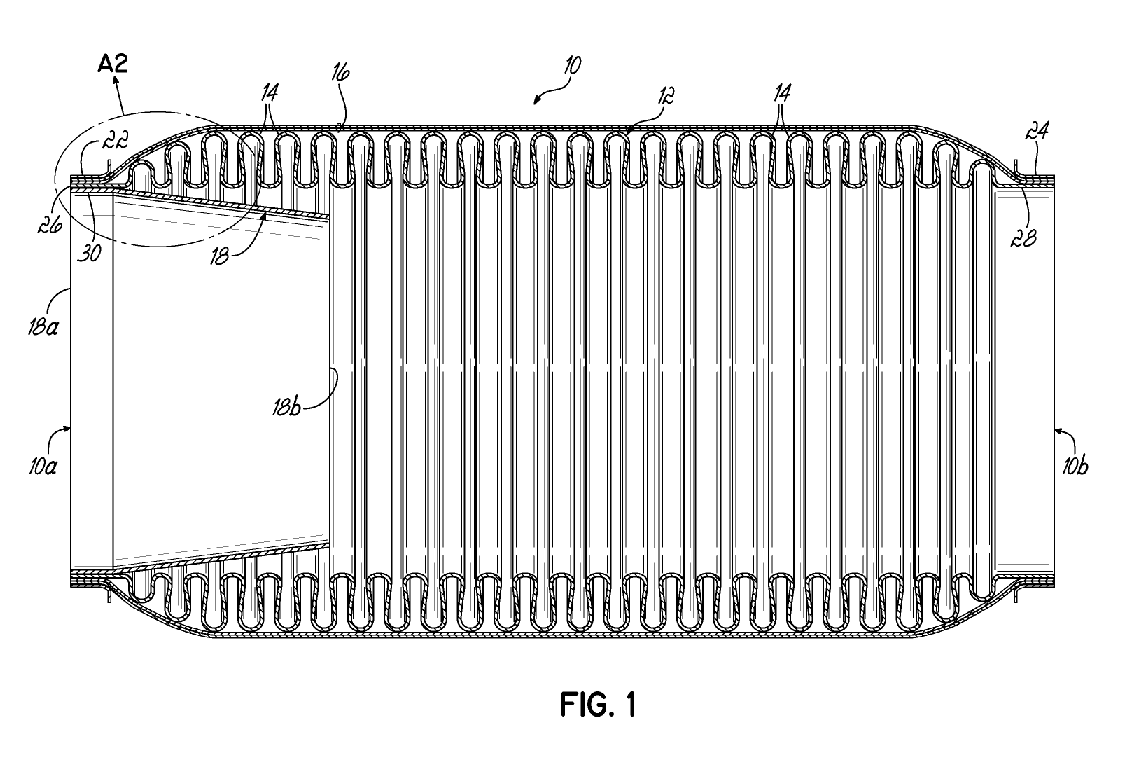

Turning to FIG. 1 a coupling 10 comprises an elongated bellows 12 of multiple connected convolutions 14, an optional mesh or braid sleeve 16 surrounding bellows 12, and an internal flow control tapered element or liner 18 at an entry end 10a of a coupling 10. For descriptive purposes, entry end 10a is preferably operatively disposed at end 30 of the flow control element or liner 18, and a coupling discharge end 10b is oriented at the other end of coupling 10. Gas flow then in FIG. 1 is left-to-right.

Compression rings 22, 24 secure respective ends of sleeve 16 to the respective ends 26, 28 of bellows 12 and to annular straight end 30 or cylindrical gas entry end 30 of element 18. Element or liner 18 has an upstream portion of tapered configuration 18a and terminates in a circular opening 18b, as shown in FIG. 1.

This end construction is illustrated at encircled area A2 of FIG. 1 with like numbers identifying like parts.

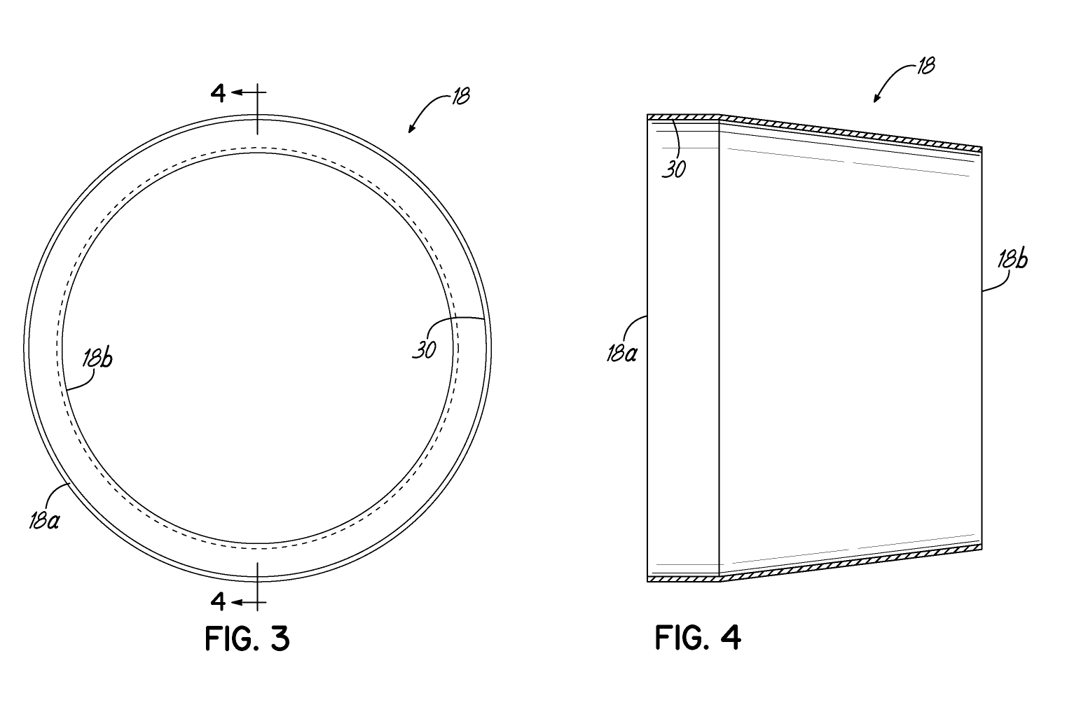

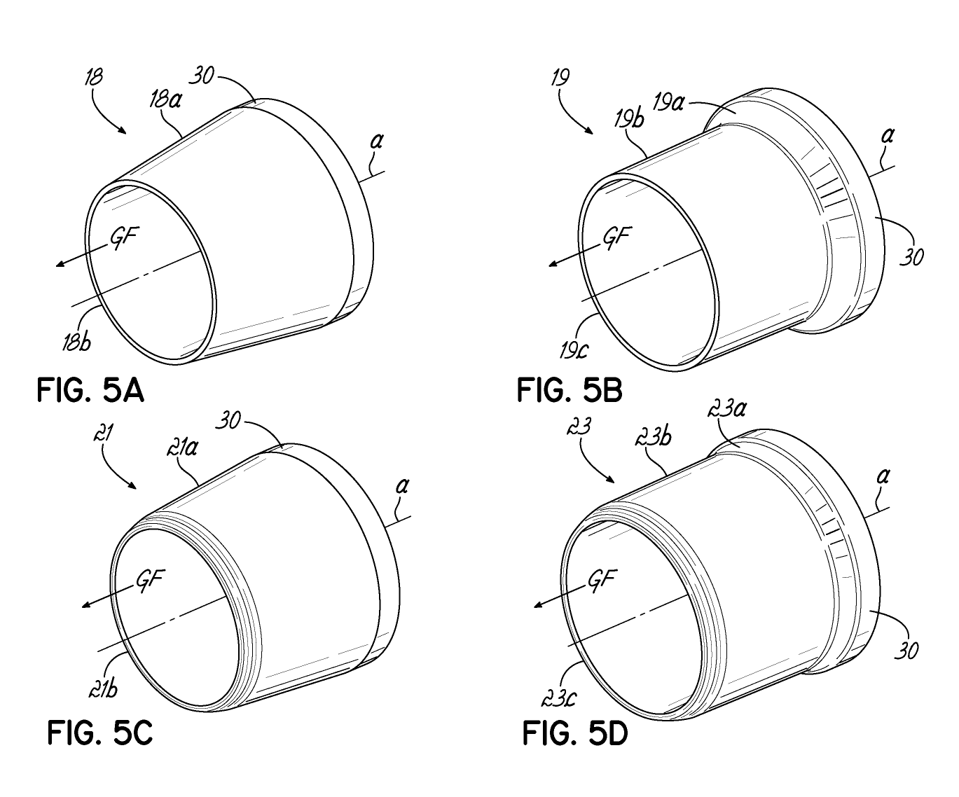

It will be appreciated that the flow control elements described herein, as illustrated in FIGS. 1-5D, have an annular or cylindrical upstream end 30. Alternative flow control elements are illustrated in FIGS. 5A-5D. Element 18 FIGS. 1-4 and 5A tapers radially inwardly at 18a from end 30 to downstream element end 18b.

In FIG. 5B, cylindrical end 30 of element 19 tapers at 19a to straight section 19b extending to downstream end 19c.

In FIG. 5C, cylindrical upstream end 30 is connected to tapered section 21a of element 21 which terminates in a tapered tail end 21b.

In FIG. 5D, cylindrical upstream end 30 tapers to straight section 23b which terminates at tapered tail end or constriction 23c.

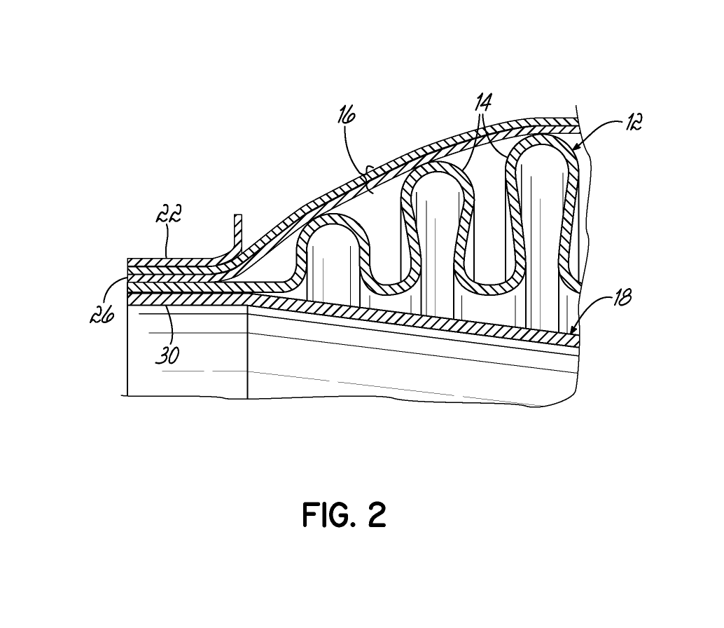

It is also noted that the optional mesh or braid 16 of a coupling 10 may be of one, two, or more plies, two being illustrated in FIGS. 1 and 2.

Flow control element 18 can be provided in a variety of shapes for controlling flow of hot gases through coupling 10 all as illustrated in FIGS. 1-5D.

Elements or liners 18, 19, 21 and 23 are preferably symmetrical about coupling axes “a” from a gas entry end at 30, respectively, to respective opposite discharge or tail ends as shown.

Exhaust gas flows into and through the elements along axes “a” are illustrated by the various multiple gas flow indicating arrows “GE” in FIGS. 5A-5D. Hot exhaust gas flows into entry ends of the elements. The gas flow is radially inwardly concentrated toward coupling axes “a” by the respective structures of the elements 18, 19, 21 and 23 including intermediate and tail end sections as illustrated. Gas flows (arrows GF) through the couplings flow outwardly of the coupling at their respective discharge ends at 18b, 19c, 21b and 23c. Each flow control element of FIGS. 5H-5D produces unique and different effects on the gas flowing therethrough as will be appreciated.

It will be appreciated the hot gas is directed through the coupling, from one end to the other by the respective flow control elements and away from bellows 12 so bellows 12 is not undesirably heated by direct gas flow contact.

Whichever gas flow element (FIGS. 5A-5D) is selected for a particular application, it will be appreciated that hot gas flow is directed by a respective gas flow element from a coupling or bellows gas entry end 10b to a coupling or bellows discharge end 10a and away from the surrounding convoluted bellows 12. Moreover, it is appreciated a portion of the gas flow (arrows GF) downstream of elements 18, 19, 21 and 23 is unconfined, with no liner or flow directing element between the gas and the bellows 12. Nevertheless, gas is directed through the coupling 10 without unduly contacting and heating bellows 12 despite the respective gas directing element being shorter than the axial extension of the bellows 12.

This is accomplished without the use of any additional or second liner such as used in prior couplings. Heat transfer to the bellows is never-the-less reduced. There is no liner which creates friction with the bellows and undesired rigidity in the coupling. There are no interengaging liner portions or interlocking configurations to bind or wear as the coupling expands or contracts. No additional or second liner of even short length is required, and any differential thermal response in the bellows convolutions is eliminated or substantially reduced. Noise and vibration is reduced.

Any number of differently configured gas flow controlling elements can be used within the scope of the invention. Thus it will appreciated that the selection and use of the flow control elements such as shown in FIGS. 5A-5D, or as selected of even different configuration each provide a different effect on the gas flowing therethrough, and are based on the flow shapes desired for a particular application, yet without any second gas receiving tube at the downstream end of the coupling all as will be appreciated by reference to the structure.

Note that the incoming gas flow in the embodiments herein is concentrated or otherwise directed within the coupling and toward the discharge end thereof without any further liner or element between the downstream end of the relatively short gas flow controlling element and the discharge end of the coupling.

Gas flow through the coupling thus follows along an entry path to a discharge end but without structure confining the flow in the coupling from the point where it exits the flow directing element and the point where it discharges from a discharge end of the coupling.

Finally, it will of course be appreciated that the couplings described herein are preferably used, for example, in connecting two exhaust gas conduits at respective ends of the coupling.

These and other modifications and a advantages will become readily apparent to those of ordinary skill in the art without departing from the scope of the invention and applicant intends to be bound only by the claims appended hereto.

What is claimed is:

1. A flexible coupling comprising:
An elongated coupling having a first length defined at least in part by a multiple convolution bellows extending along the entire length of the coupling from a bellows gas entry end to a bellows gas discharge end;
a single gas flow directing liner disposed within said bellows proximate said bellows entry end,
said liner having a length shorter than the first length.

2. A coupling as in claim 1 wherein said liner is tapered radially inwardly from proximate said entry end.

3. A coupling as in claim 1 wherein said liner has a cylindrical gas entry end.

4. A coupling as in claim 2 wherein said coupling has a gas flow path there through, a portion of said gas flow path defined by said gas flow directing liner, and another downstream portion of said gas flow path being unconfined by any liner within said coupling.

5. A coupling as in claim 1 including a gas flow path through and within said bellows, a first portion of said path defined within said gas flow directing liner and another portion of said path being unconfined by said liner and extending within said bellows from said flow directing liner to said discharge end of said bellows.

6. A coupling as in claim 5 wherein said flow directing liner is configured to direct gas flow radially inwardly of said bellows and toward said bellows discharge end.

7. A coupling as in claim 1 wherein said liner has a cylindrical entry end and a straight cylindrical downstream end.

8. A coupling as in claim 7 wherein said cylindrical end downstream end terminates in an inwardly directed constriction.

9. A coupling as in claim 2 wherein said liner has a further inwardly tapered restriction downstream of said radially inwardly tapered portion.

10. A coupling as in claim 1 further including a flexible sleeve surrounding said bellows.

11. A coupling as in claim 1 wherein the length of said liner is shorter than 50 percent of said first length of the coupling.

12. A coupling as in claim 1 wherein the length of said liner is shorter than 30 percent of said length of said coupling.
